(19) United States
(12) Patent Application Publication
(10) Pub. No.: US 2005/0161016 A1
(43) Pub. Date: Jul. 28, 2005

(54) Rotary internal combustion engine with adjustable compression stroke

(76) Inventor: Kamen George Kamenov, San Francisco, CA (US)

Correspondence Address: KAMEN GEORGE KAMENOV, 2470 FULTON ST. # 5, SAN FRANCISCO, CA, 94118, US

(21) Appl. No.: 10/762,783

(22) Filed: Jan. 23, 2004

(51) Int. Cl. F02B 53/00

(52) U.S. Cl. 123/245

(57) ABSTRACT

A rotatably alternating air or water cooled two-stroke internal combustion engine comprising a cylindrical casing, and a rotor comprising two radially extending vanes affixed to a shaft rotatably mounted within the casing upon two end plates affixed to the casing. Two longitudinally extending walls unitary or affixed to the casing. Sealing strips provided between said walls and the shaft and between the vanes, the casing and the end plates respectively. The casing and, or the end plates equipped with plurality of ports which communicate with interior chambers formed between the vanes and the walls, allowing for intake of combustible air-fuel mixture and exhaust thereafter. Ignition means delivering a spark at the end of each working cycle. An extendable connecting rod assembly converting the oscillating bidirectional rotary motion of the output shaft into a continuous unidirectional motion of the main shaft.

### BACKGROUND OF THE INVENTION

This invention relates to a rotatively reciprocating vane internal combustion engine having few moving parts high efficiency, and a low weight-to-power ratio.

In an age of environmental concerns and waning natural resources, a lightweight, highly efficient, low fuel consumptive engine has been vigorously sought.

In the past, attempts have been made to improve on reciprocating piston engines but their inherent complexity and high weight-to-power ratio has proven limiting. Also rotary or Wankel design engines have become relatively highly developed, they still exhibit daunting problems in rotor sealing and cost parameters. For example, Wankel engine is difficult to manufacture, it has a short life, it has a problem of loosing its lubrication and seizing up. It has a poor gas mileage, high oil consumption and high exhaust level. For every three turns of the working piston there is only one rotation of the main power output shaft which results in an excessive friction inside the working chamber between the piston and the casing.

Some attempts have been made to provide rotary vane engines, which abate some of the aforementioned problems. For example, U.S. Pat. No. 4,599,976 to Meuret discloses the utilization of spherically shaped chamber and accordingly shaped vanes, which are used to sequentially compress and expand a combustive mixture. It should be noted, however, that the patented system has the following disadvantages.

In Meuret patent the ratio between the volume of the chamber and the diameter of the vanes is constant. If the volume of the sphere chamber changes it automatically and proportionally changes the radius of the vanes. In a cylindrical chamber the volume of the chamber can be changed either by simply changing the length of the cylinder or by changing the radius of the cylinder. In each case there is going to be a different output even thought the volume is the same. A cylindrical engine is much easier to manufacture and seal, and to open and repair.

Another example of a prior art attempt to overcome some of the disadvantages of existing engines is the U.S. Pat. No. 4,884,532 to Tan, which teaches an extremely complex swinging piston internal combustion engine. While Tan has made certain admirable advantages, his device suffers from the following disadvantages.

The Tan engine is big and bulky. There is no power-to-weight ratio advantage over the conventional engine. It would be difficult to manufacture and repair it. It would be difficult to balance it and it would only work as a diesel engine.

Unlike the prior art systems, the present invention provides essentially only one moving element, its rotably reciprocating vane piston. Because of pressure balancing on opposite sides of the vane members they may be constructed of lightweight material and the need for heavy bearing and counter-balancing means are virtually eliminated. The invention is capable of running on multiple types of conventionally available fuel and may conceivably be operated on four chamber two stroke cycles, two chamber two stroke cycles, or diesel cycles.

### SUMMARY AND OBJECTS OF THE INVENTION

The instant rotating vane engine comprises a simple rotary vane assemblage mounted within a cylindrical housing having a fixed abutment wall and means for the intake and exhaust of combustible mixture. Primary engine valving is accomplished by simple ports of apertures in the cylindrical housing and, or the end plates or heads for the housing and by the reciprocating motion of the vane assemblage which opens and closes the apertures at the appropriate moment. The bidirectional rotation of the output shaft, upon which the vanes are mounted, may be made unidirectional by well-known external gearing system.

The primary object of the present invention is to provide a rotary internal combustion engine, which quickly, efficiently and economically converts thermal energy into usable kinetic energy.

A further object of the present invention is to provide a power plant with essentially one moving element with concomitant savings in materials, weight, labor and manufacturing costs.

A further object of the present invention is to provide a rotary engine with operating vane wherein the forces on opposite sides of the vanes are essentially balanced and the vibrations are virtually eliminated.

Other objects and advantages of the present invention will become apparent from the following drawings and description.

The accompanying drawings show, by way of illustration, the preferred embodiments of the present invention and the principles of operation therefor. It should be recognized that other embodiments of the invention, applying the same or equivalent principles, may be utilized and structural changes may be made as desired by those skilled in the art, without departing from the spirit of the invention.

### BRIEF DESCRIPTION OF THE DRAWINGS

FIG. 1 is a cutaway sectional view across the instant rotating vane engine incorporating an essential swinging piston output shaft forming 4 chamber rooms inside a cylinder;

FIG. 2 shows schematically a cutaway cross section side view of the engine taken along the vertical line passing through the axis of the swinging piston shaft;

FIG. 3 shows a front view of an alternative connecting rod assembly converting the alternating bidirectional rotary motion of the swinging piston output shaft 6 into a continuous unidirectional rotary motion of the main shaft 22 (FIG. 3). The break in the rod at 27 allows for extending and adjusting the length of the rod according to the desired compression inside the working chambers thus regulating the length of the stroke without the need of replacing the rod. The lower part of said rod is rotatably attached to the flywheel via a slot on that flywheel and is affixed to it with a fastening member comprising a bolt and a nut;

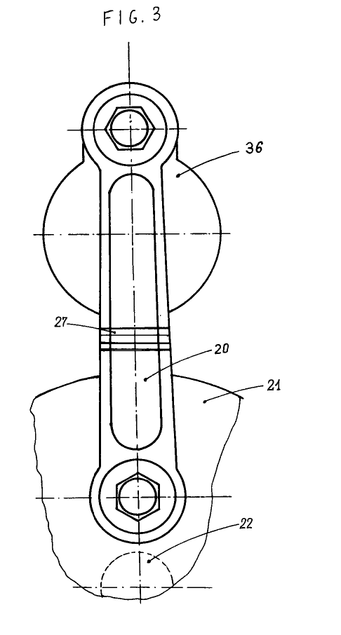

FIG. 4 shows schematically the relation of the length of the radius R₁ or R₂ formed between the center of the main shaft 22 (FIG. 3) and the lower end attachment of the crank pin 20 (FIG. 3) to the changing volume of the four chambers a, b, c and d (FIG. 1) formed by the swinging piston 6 (FIG. 1) inside the main cylinder of the engine, in operation. A shorter crank pin creates a longer radius and causes the swinging piston 6 to increase its rotational angle allowing for a longer stroke thus instantly creating a higher compression inside the working chambers;

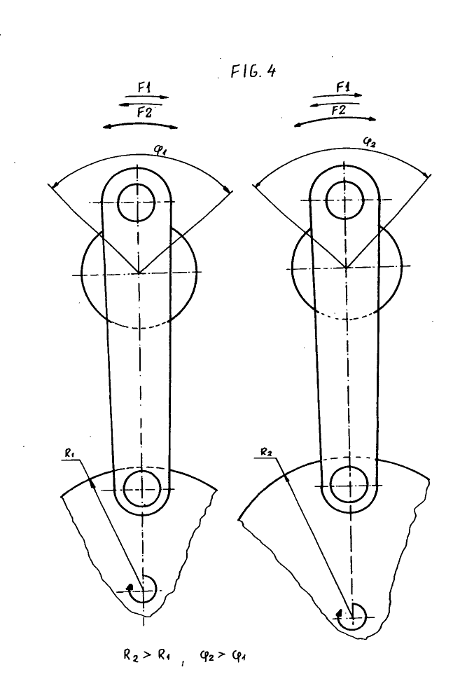

FIG. 5 shows schematically a sectional view of the engine with an alternative version of the operative vanes.

### DETAILED DESCRIPTION

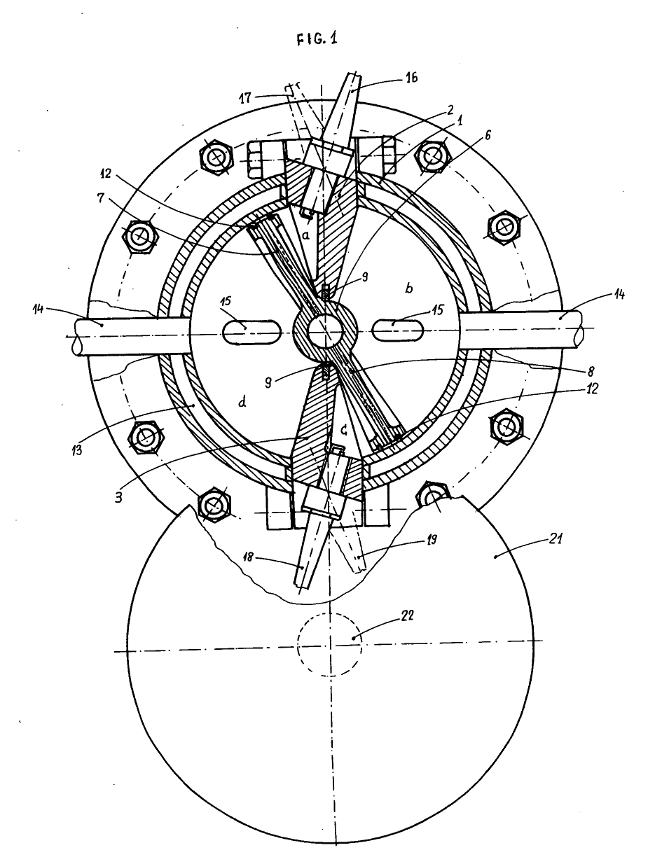

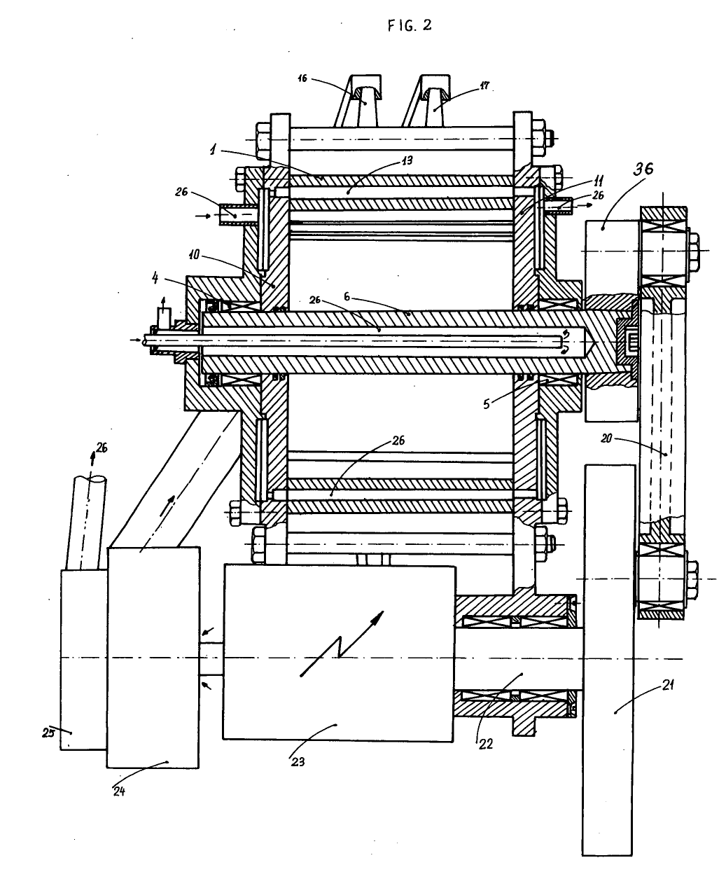

With reference to FIG. 1 in the drawings, the essential concept of the present invention and the means by which it is intended to operate may be appreciated. At 1, a double-walled, water-jacketed 13, longitudinally extending cylindrical casing is shown, in section. The casing may be conveniently made of aluminum, steel or other commonly used materials. The casing is equipped at 2 and 3 with longitudinally extending walls, which can be unitary with, or affixed to the casing 1. A rotary shaft 6 is suitably rotably mounted within the casing upon end plates 10 and 11. (FIG. 2) for the casing. The shaft is supported in the casing by commonly known bearing means 4 and 5 for mounting a rotary shaft in a motor, pump, or compressor. The shaft is partially hollow to allow the flow of cooling fluids inside it. Similar to the cylindrical casing the end plates are also double-walled to allow coolant to flow freely from the water pump 25 through all the cavities of the cylinder, the end plates and the shaft in a closed circuit 26.

Fixedly attached to, or unitary with the shaft 6 are rotating vanes 7 and 8. Suitable seals 9 and 12 are provided between the walls 2 and 3 and the shaft 6 and between the vanes 7 and 8 and the casing 1 respectively.

The casing 1 is also equipped with plurality of ports, 14 and 15, which communicate between interior chambers a, b, c and d formed, as shown, between the vanes 7 and 8 and the casing walls 2 and 3. These ports allow the intake (15) of combustible fluids and lubricants and the exhaust (14) thereof from the aforementioned casing chambers. At 24 a compressor, a carburetor or an injection system delivers fuel mixture into the engine. At 23 a box is shown, containing the electrical and electronic systems of the engine. The intake ports 14 may be replaced by injection means.

Similarly, there are four ignition means, preferably comprising spark plugs, shown schematically at 16, 17, 18 and 19. The precise details of the ignition means, the valving means, the seals are not, in themselves subject of the present invention and various types of known such components could be used provided that the operative characteristics, in combination, are set forth. For example, Wankel type seals could be used.

The particular mode of operation of the invention shown in FIGS. 1 and 2 now will be described. The vanes 7 and 8 can rotate clockwise and counterclockwise. In so moving the vanes continuously change the volume of the chambers a, b, c, and d.

In a two-stroke, four chamber operation the engine works as follows. In the position of the vanes shown in FIG. 1, vanes 7 & 8 are moving in counterclockwise direction and air-fuel mixture and lubricant are being drawn in through ports 15 to the expanding chambers a & c after the vanes move past these ports.

Simultaneous with the expansion of the chambers a & c are the contractions of the chambers b & d. The previously drawn combustible fluid mixture in chambers b & d is being compressed by the vanes 7 & 8 against the walls 3 & 2. At maximum compression in chambers b & d, ignition means 17 & 19 fire and cause vanes 7 & 8 to rotate now clockwise with concomitant expansion of these chambers. At the same time the burned exhaust gases in these chambers are free to leave through the ports 14, after the vanes open these ports by moving past them. The fuel mixture in chambers a & c is now being compressed and new fuel mixture and lubricant is being drawn in in chambers b & d. The openings of the exhaust ports (14) are always bigger in diameter or in size than the openings of the intake ports (15) in order for the exhaust to start exiting before the intake begins thus releasing pressure in the appropriate ignited working chambers.

At maximum compression, the igniters fire sequentially in couples, in the known manner.

Since the vanes 7 & 8 open and close intake and exhaust ports 15 & 14 for appropriate chambers, just by moving past them, there is no need for additional internal or external valving.

The four chamber two-stroke operation of the engine may be replaced by a dual chamber operation where all of the processes described above are essentially the same for each chamber. For example, only the left or the right side and only two chambers in operation, a & d or b & c may be used, therefore only half of the engine, comprising half a cylinder, may be built.

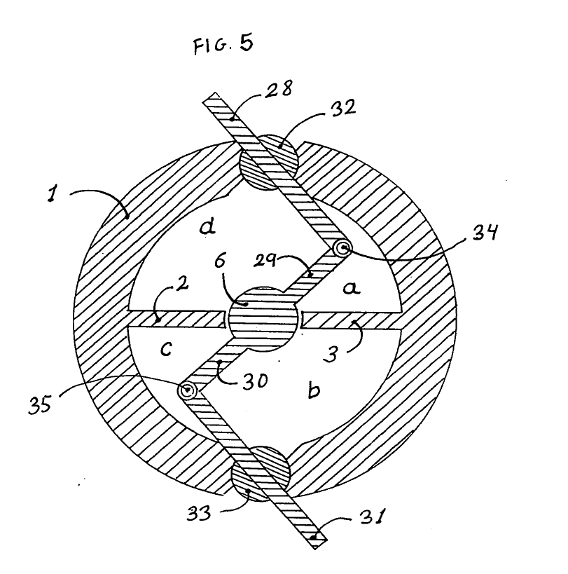

In the alternative embodiment of FIG. 5, the rigid longitudinal vanes 7 and 8 are replaced by articulating vanes 28, 29, 30 and 31. In operation, with respect to the vane segments 29 and 30 the operation is as previously described with respect to FIG. 1. However, because of the articulated vane sections 28 an 31, the shaping of the chambers a, b, c and d is different from that shown in FIG. 1. The articulated vane segments 28 and 31 are suitably mounted for slidable rotation within slide-bearing means 32 and 33. The bearings are rotatable within the casing while allowing vane segments 28 and 31 to slide therethrough.

As shown in FIG. 5, chambers are formed between the walls 2 and 3 and the vanes 28-29 and 30-31. As the vane segments 29 and 30 rotate clockwise, the vane segments 28 and 31 respectively nutate about the joints 34 and 35 while simultaneously sliding within the bearings 32 and 33. The chambers a, b, c and d, therefore, expand and contract in a balanced fashion similar to the straight chambers shown in the embodiment of FIG. 1.

Thus the preferred embodiments of the invention have been illustrated and described. It must be clearly understood that the preferred embodiments are capable of variation and modification and are not limited to the precise details set forth. For instance, it is apparent that the parts may be modified in size and materials without affecting the essence of the invention. This invention includes all variations and modifications, which fall within the scope of appended claims.

1-4. (canceled)

5. A four chamber, two-stroke rotatably reciprocating vane internal combustion engine comprising:
a cylindrical casing (1), air-cooled or water cooled by having a water-jacketed double wall wherein cooling fluid is passing through it;
said casing equipped with longitudinally extending walls (2 & 3) being unitary or affixed to the cylindrical casing;
vanes (7 & 8) unitary or affixed to a power output rotary shaft (6), said power output rotary shaft rotatably alternating in back and forth fashion and together with the vanes referred to as the swinging piston;
said power output rotary shaft (6) in bigger engines may be hollow for water cooling and is mounted within the cylindrical casing upon water-jacketed end plates or head (10 & 11);
sealing strips (9 & 12) embodied in grooves and provided between the walls (2 & 3) and the power output rotary shaft (6), between the vanes (7 & 8), the cylindrical casing (1) and the end plates (10 & 11) respectively;
four working chambers (a, b, c and d) formed between the vanes (7 & 8) and the walls (2 & 3) inside the casing change their volume in accordance with the alternating position of the vanes;
two sets of ports (14 & 15), each one set shared by two chambers, ports (15) for intake of combustible air-fluid mixture and lubricating oil only and ports (14) for exhaust only;
wherein the apertures of the exhaust ports are always larger in size or bigger in diameter then the apertures of the intake ports to allow release of pressure of the exhaust before intake begins, and may be located in the cylindrical casing (1) or on the end plates (10 & 11); and
four ignition means (16, 17, 18 & 19), one for each chamber igniting the compressed fuel at maximum compression, firing sequentially in couples into the appropriate working chamber rooms at the end of each cycle.

6. A four chamber, two-stroke rotatably reciprocating vane internal-combustion engine according to claim 1, further comprising means for imparting continuous rotation from the alternating power output shaft (6) to a unidirectionally rotating main shaft (22) comprising a crank (36) secured to said power output shaft;
a connecting rod (20) swivably mounted to said crank and to the unidirectionally rotating shaft (22) through a slot on a flywheel (21),
wherein said connecting rod pivots back and forth across the vertical line passing through the axis of the power output shaft (6) and an axis of the unidirectionally rotating main shaft (22), and
wherein said connecting rod being extendable and adjustable in length at point (27);
a lower part of said connecting rod being rotatably and movably attached to the slot formed on the flywheel (21) and being fixed together with a fastening member via the slot to said flywheel in a predetermined position thus adjusting the length of the stroke of the swinging piston assembly for an optimum performance; and
said fastening member being comprised of a bolt and a nut coupled to the lower part of the rod and to the slot on the flywheel.

7. A four chamber, two-stroke rotatably reciprocating vane internal combustion engine according to claim 1, wherein as alternative embodiment, the rigid longitudinal vanes (7 & 8), are replaced by articulating vanes (28, 29, 30 & 31) forming four chamber rooms inside the cylinder housing (1); articulated vane segments (28 & 31) forming a different shaping of the chambers a, b, c and d; said vanes suitably mounted for slidable rotation within slide-bearing means (23 & 33); said vanes nutate about the joints (34 & 35) while simultaneously sliding within the bearings (32 & 33); said bearings rotatable within the casing while allowing the vane segments (28 & 31) to slide therethrough.

8. A four chamber, two stroke rotatably reciprocating vane internal combustion engine according to claim 1, wherein the intake ports (15) incorporate injection means while at the same time supplying the interior of the four chamber rooms with sufficient air flow for the burning fuel and lubricating oil for the working piston.

9. A two chamber, two-stroke rotatably reciprocating vane internal combustion engine, wherein for purposes of economy in size, material and fuel only one set of ports for intake and exhaust, two spark plugs and one vane thus one half of the engine as shown in FIG. 1, either left or right side and only two chambers in operation, a & d or b & c may be used therefore only one half of the engine, comprising half a cylinder may be built.
